(19) United States
(12) Patent Application Publication
(10) Pub. No.: US 2011/0074207 A1
(43) Pub. Date: Mar. 31, 2011

(54) BRAKE DEVICE

(75) Inventor: Haruo ARAKAWA, Toyota-shi (JP)

(73) Assignee: ADVICS CO., LTD., Kariya-city (JP)

(21) Appl. No.: 12/885,889

(22) Filed: Sep. 20, 2010

(30) Foreign Application Priority Data
Sep. 29, 2009 (JP) 2009-225315

(51) Int. Cl. B60T 13/16; B60T 13/66; B60T 13/20

(52) U.S. Cl. 303/10

(57) ABSTRACT

A brake device comprising a master cylinder (2), a braking mechanism (C), a plurality of pedal operation detecting sensors (BS), a fluid pressure-generating mechanism (A) driven by a motor (M) to generate fluid pressure and to supply the generated fluid pressure to an input side of the braking mechanism (C), control means (B) for controlling the electric current value impressed on the motor (M) in accordance with the output values of the pedal operation detecting sensors (BS), and a fluid pressure sensor (FS) for detecting fluid pressure supplied to the input side of the braking mechanism (C) in order to render the brake device capable of executing control of the electric current value impressed on the motor even when primary failure occurs in the plurality of pedal operation detecting sensors; wherein the control means (B) controls the electric current value impressed on the motor (M) in accordance with the output values from the plurality of pedal operation detecting sensors (BS) in a case in which the relationship of the output values is within a normal range, and identifies the pedal operation detecting sensor (BS) for use in controlling the electric current value on the basis of the relationship between each of the output values and the output value from the fluid pressure sensor (FS) in a state in which no electric current is being impressed in a case in which the relationship is outside the normal range.

### BACKGROUND OF THE INVENTION

1. Field of the Invention

The present invention relates to a brake device provided with a plurality of pedal operation detecting sensors for detecting the amount of operation of a brake pedal, and designed to control the electric current value impressed on the motor in accordance with the output value of the sensors.

2. Description of the Related Art

Patent Document 1 describes a vehicle brake device for detecting the amount of operation on the brake pedal using a sensor, impressing an electric current on the motor on the basis of the output value of the sensor, and adjusting the braking force on the wheels. In this brake device, the amount of operation of the brake pedal is detected by an input detector A25 for detecting the operation stroke and by an input detector B26 for detecting the operating load. These output values are transmitted to an electronic control device 13, and the electric current value to be impressed on the motor is controlled by the electronic control device 13.

The brake device described in Patent Document 1 is configured to detect fluid pressure generated by a master cylinder 60 and to detect the electric current of a motor 110, and to transmit such information to the electronic control device 13. The motor 110 provided to a brake fluid pressure-generating device 10 is subjected to feedback control on the basis of these output values, allowing the reliability of the control to be increased.
[Patent Document 1] Japanese Patent No. 4088802

### SUMMARY OF THE INVENTION

Since the brake device described in Patent Document 1 is provided with the input detector A25 and the input detector B26, a control method can be adopted in which the detectors are assumed to operate normally and the electric current impressed on the motor is controlled only when the output values from the detectors have a fixed correlation. According to such a control method, it can be determined that one of the detectors has failed when the above-mentioned correlation is not present.

In this case, however, it is impossible to identify which of the detector has failed, preventing the use of the output values from both of the detectors and leaving no other choice but to stop controlling the electric current impressed on the motor. In other words, the emergency brake must be operated in a case of simple primary failure of the detectors, making it unlikely that sufficient safety can be ensured. It is therefore desirable to continue controlling the electric current impressed on the motor by efficiently using the output value from the still-operating detector and the output value for feedback control.

The present invention was devised in light of the above-mentioned problems, and an object thereof is to provide a brake device capable of controlling the electric current impressed on the motor even when a plurality of pedal operation detecting sensors has developed a primary failure.

The brake device according to a first aspect of the present invention is a brake device comprising a master cylinder for generating fluid pressure corresponding to the operation of a brake pedal; a braking mechanism for receiving the fluid pressure generated by the master cylinder, and applying braking force to a wheel using the supplied fluid pressure; a plurality of pedal operation detecting sensors for detecting the amount of operation on the brake pedal; a fluid pressure-generating mechanism driven by a motor to generate fluid pressure and to supply the generated fluid pressure to an input side of the braking mechanism; control means for controlling the electric current value impressed on the motor in accordance with the output values of the pedal operation detecting sensors; and a fluid pressure sensor for detecting fluid pressure supplied to the input side of the braking mechanism, wherein the control means controls the electric current value impressed on the motor in accordance with the output values from the plurality of pedal operation detecting sensors in a case in which the relationship of the output values is within a predetermined normal range, and identifies the pedal operation detecting sensor for use in controlling the electric current value to be impressed on the motor on the basis of the relationship between each of the output values from the plurality of pedal operation detecting sensors and the output value from the fluid pressure sensor in a state in which no electric current is being impressed on the motor in a case in which the relationship of the output values from the plurality of pedal operation detecting sensors is outside the normal range.

According to the first aspect, the output value from a fluid pressure sensor that is separate from the plurality of pedal operation detecting sensors is used, and the pedal operation detecting sensor appropriate for control is identified in a case in which, for example, one of the plurality of pedal operation detecting sensors has failed and the relationship of the output values from the plurality of pedal operation detecting sensors is outside a predetermined normal range. Therefore, control (“drive-by-wire control” hereinbelow) of the electric current value impressed on the motor can subsequently be continued based on the output value of the identified pedal operation detecting sensor. Since fluid pressure sensors are generally provided for feedback control and the like, there is no need to increase the number of components in the brake device, and the reliability of the drive-by-wire control can be improved.

According to a second aspect of the present invention, the fluid pressure-generating mechanism is constructed from the master cylinder and an output piston for causing fluid pressure to be generated in the master cylinder, and the output piston is controlled by the motor.

If the fluid pressure-generating mechanism for use in drive-by-wire control is constructed from the master cylinder and the output piston provided to a conventional brake device, as in the second aspect of the present invention, there is no need to provide a separate fluid pressure-generating mechanism for drive-by-wire control, and a brake device advantageous in terms of cost and ease of mounting can therefore be provided.

According to a third aspect of the present invention, a determination is made as to whether the relationship between each of the output values from the plurality of pedal operation detecting sensors and the output value from the fluid pressure sensor is within a predetermined stipulated range, and the pedal operation detecting sensor for use in controlling the electric current value to be impressed on the motor is identified in a case in which the relationship of the output values from the plurality of pedal operation detecting sensors is outside the normal range.

According to the third aspect, the pedal operation detecting sensor for use in drive-by-wire control can be identified by merely determining whether the relationship between each of the output values from the plurality of pedal operation detecting sensors and the output value from the fluid pressure sensor is within the predetermined stipulated range. Therefore, only a small number of determination steps is required, and the control program can be simplified.

According to a fourth aspect of the present invention, the correlation between each of the output values from the plurality of pedal operation detecting sensors and the output value from the fluid pressure sensor is compared, and the pedal operation detecting sensor for use in controlling the electric current value to be impressed on the motor is identified, in a case in which the relationship of the output values from the plurality of pedal operation detecting sensors is outside the normal range.

According to the fourth aspect, the pedal operation detecting sensor having the greater correlation with the fluid pressure sensor can be selected to allow more-precise drive-by-wire control to be performed even after a primary failure in cases such as those in which, for example, the relationship of the output values from the plurality of pedal operation detecting sensors is outside the normal range but in which a determination is made that there is no abnormality in the relationship between each of the output values from the plurality of pedal operation detecting sensors and the output value from the fluid pressure sensor.

According to a fifth aspect of the present invention, the plurality of pedal operation detecting sensors includes a displacement sensor for detecting the amount of movement of the brake pedal, and a load sensor for detecting the operating force on the brake pedal.

Assuming that the plurality of pedal operation detecting sensors includes a displacement sensor and a load sensor, as in the fifth aspect of the present invention, the sensors are the generally commonly used all-purpose components, and can be used to advantage in terms of cost reduction and design latitude.

### BRIEF DESCRIPTION OF THE DRAWINGS

FIG. 1 is a schematic view of the brake device according to an embodiment of the present invention;

FIG. 2 is a partial block diagram of the brake device;

FIG. 3 is a flowchart of brake control;

FIG. 4 is a flowchart of brake control at the time of a sensor abnormality;

FIG. 5 is a relationship diagram of output values when sensor abnormality has been determined.

### DESCRIPTION OF THE PREFERRED EMBODIMENTS

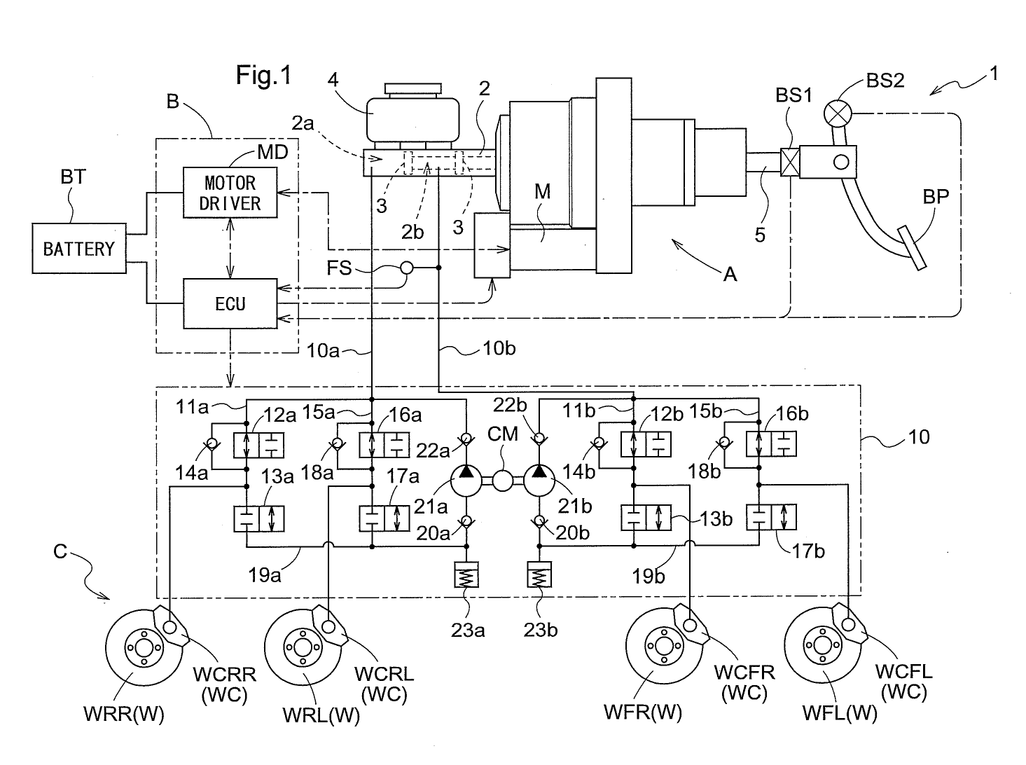

Embodiments of the brake device according to the present invention are described below with reference to the drawings. FIG. 1 shows a schematic view of a brake device according to the present embodiment. The brake device 1 has a fluid pressure-generating mechanism A for generating fluid pressure in accordance with the amount of operation applied to a brake pedal BP, a load sensor BS1 for detecting the amount of operation applied to the brake pedal BP as a tread force by the operator, a displacement sensor BS2 for detecting the amount of operation as displacement (angle), control means B for applying current to the fluid pressure-generating mechanism A using drive-by-wire control on the basis of the sensor output, a braking mechanism C for braking a wheel W, a fluid pressure circuit 10 for transmitting fluid pressure to the braking mechanism C, and a fluid pressure sensor FS for detecting the fluid pressure of the fluid pressure circuit 10.

The fluid pressure-generating mechanism A has a master cylinder 2 and is equipped with an output piston 3 capable of sliding in relation to the master cylinder 2. In the present embodiment, the master cylinder 2 is of the so-called tandem type construction, and has a first fluid pressure chamber 2a and a second fluid pressure chamber 2b. A master reservoir 4 has two flow paths, the flow paths being respectively in communication with the first fluid pressure chamber 2a and the second fluid pressure chamber 2b.

The fluid pressure-generating mechanism A is usually actuated by the control means B performing drive-by-wire control on the basis of the output value from the load sensor BS1 and/or the displacement sensor BS2. In other words, the output piston 3 is driven independently from an input rod 5 via a motor M that rotates in accordance with the impressed current from the controls means B, and fluid pressure is generated in the fluid pressure chambers 2a, 2b. When drive-by-wire control is not performed, operation of the brake pedal BP is transmitted directly to the input rod 5, and the input rod 5 engages with the output piston 3 and presses the output piston 3 inward. As a result, fluid pressure is generated in the fluid pressure chambers 2a, 2b, and the braking mechanism C generates a braking force. This brake actuation state is referred to below as “rod control.”

The control means B is constructed from an ECU having a microcomputer as the core member, a motor driver MD for impressing an electric current on the fluid pressure-generating mechanism A, and other similar components. A battery BT for supplying electrical power is connected to the ECU and the motor driver MD. The control means B controls the motor M and a variety of control valves associated with the fluid pressure circuit 10 when the braking force applied to the wheel W is to be controlled.

The braking mechanism C is constructed from wheel cylinders WC (front right wheel cylinder WCFR, front left wheel cylinder WCFL, rear right wheel cylinder WCRR, rear left wheel cylinder WCRL) provided to each wheel W (WFR, WFL, WRR, WRL), and a brake pad (not shown) for allowing friction-based braking force to be generated in each wheel by the actuating force of the wheel cylinders WC.

The fluid pressure circuit 10 is constructed from a first fluid pressure circuit 10a and a second fluid pressure circuit 10b, which are connected with the master cylinder 2. The first fluid pressure circuit 10a is in communication with the first fluid pressure chamber 2a, as well as the rear right wheel cylinder WCRR and the rear left wheel cylinder WCRL. The second fluid pressure circuit 10b is in communication with the second fluid pressure chamber 2b, as well as the front right wheel cylinder WCFR and the front left wheel cylinder WCFL.

The first fluid pressure circuit 10a further branches off into a first branching path 11a and a second branching path 15a, each of which is connected to the rear right wheel cylinder WCRR and the rear left wheel cylinder WCRL, respectively. The first branching path 11a is provided with a first normally open control valve 12a, which is normally open and is capable of switching between two positions: a communicating position and a blocking position. A first nonreturn valve 14a for allowing the flow of brake fluid from the rear right wheel cylinder WCRR toward the fluid pressure-generating mechanism A and preventing the flow of brake fluid in the opposite direction is provided to a position parallel to the first normally open control valve 12a. Similar to the first branching path 11a, the second branching path 15a is provided with a second normally open control valve 16a, which is normally open and is capable of switching between two positions: a communicating position and a blocking position. A second nonreturn valve 18a for allowing the flow of brake fluid from the rear left wheel cylinder WCRL toward the fluid pressure-generating mechanism A and preventing the flow of brake fluid in the opposite direction is provided to a position parallel to the second normally open control valve 16a.

A branch convergence path 19a is used to join together the portion of the flow path branched off from the first branching path 11a on a rear right wheel cylinder WCRR side relative to the first normally open control valve 12a, and the portion of the flow path branched off from the second branching path 15a on a rear left wheel cylinder WCRL side relative to the second normally open control valve 16a; and the branch convergence path 19a connects to the branching points of the first branching path 11a and the second branching path 15a. A first normally closed control valve 13a, which is normally closed and is capable of switching between a communicating position and a blocking position, is provided to the portion of the branch convergence path 19a that branches off from the first branching path 11a. Similarly, a second normally closed control valve 17a, which is normally closed and is capable of switching between a communicating position and a blocking position, is provided to the portion of the branch convergence path 19a that branches off from the second branching path 15a. In the branch convergence path 19a, a third nonreturn valve 20a, a fluid pressure pump 21a, and a fourth nonreturn valve 22a are successively provided to a flow path that extends from the convergence point between the flow path from the second normally closed control valve 17a and the flow path from the first normally closed control valve 13a, and reaches the branching point of the first branching path 11a and the second branching path 15a. The fluid pressure pump 21a is driven by a motor CM and is constructed so as to discharge brake fluid. A reservoir 23a is provided between the first and second normally closed control valves 13a, 17a and the third nonreturn valve 20a in the branch convergence path 19a.

The structure of the first fluid pressure circuit 10a in the fluid pressure circuit 10 was described above, but the first fluid pressure circuit 10a and the second fluid pressure circuit 10b have similar structures. Therefore, the second fluid pressure circuit 10b is provided with the same members as is the first fluid pressure circuit 10a. Accordingly, members that are the same as those provided to the first fluid pressure circuit in the drawing are assigned the same numerical symbols as those used for the first fluid pressure circuit 10a, with a “b” being substituted for the “a,” and a detailed description of the second fluid pressure circuit is omitted.

The motor CM is constructed so as to rotatably drive the fluid pressure pump 21a of the first fluid pressure circuit 10a and the fluid pressure pump 21b of the second fluid pressure circuit 10b. A fluid pressure sensor FS for measuring the fluid pressure is provided to the second fluid pressure circuit 10b. The output value from the fluid pressure sensor FS is sent to the control means B, is used in the feedback control of the motor M, and is also used to identify the normal sensor when a failure has occurred in either the load sensor BS1 or the displacement sensor BS2 of the present invention.

In a case in which braking force is applied to the wheel W, i.e., in a case in which the pressure of the wheel cylinder WC increases, the first normally open control valve 12a and the like are set to the communicating position, and the first normally closed control valve 13a and the like are switched to the blocking position. In contrast, in a case in which the braking force on the wheel W is reduced, i.e., in a case in which the pressure of the wheel cylinder WC decreases, the first normally open control valve 12a and the like are set to the blocking position, and the first normally closed control valve 13a and the like are switched to the communicating position. On the other hand, in a case in which the braking force on the wheel W is maintained, i.e., in a case in which the pressure of the wheel cylinder WC is maintained, the first normally open control valve 12a and the like are switched to the blocking position, as are the first normally closed control valve 13a and the like.

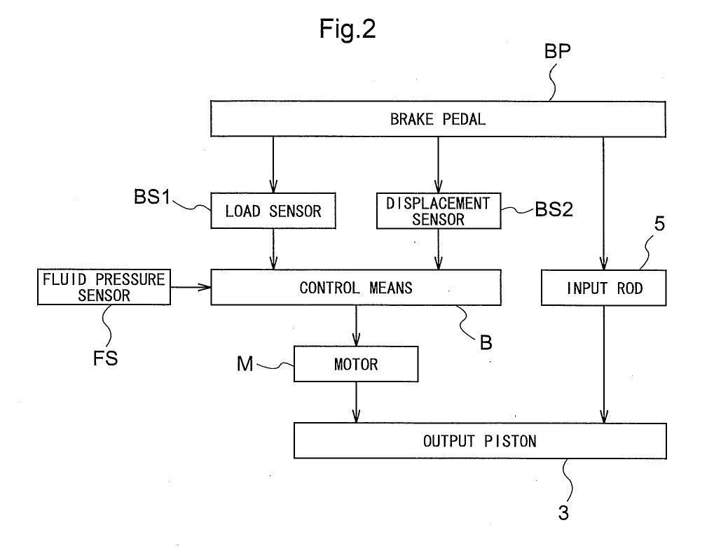

FIG. 2 is a block diagram of the main portion of the brake device 1. When there are no abnormalities in the load sensor BS1 and the displacement sensor BS2, the control means B drives the motor M according to drive-by-wire control on the basis of the output value of the sensors, and the output piston 3 is operated. In a case in which a failure occurs in either the load sensor BS1 or the displacement sensor BS2, the normal sensor is identified using the output value from the fluid pressure sensor FS, and the drive-by-wire control is performed on the basis of the output value from the normal sensor.

However, rod control is used without drive-by-wire control being performed in the period until the normal sensor is identified in a case in which either the load sensor BS1 or the displacement sensor BS2 has developed an abnormality, or in a case in which failure has occurred both in the load sensor BS1 and the displacement sensor BS2, or the like.

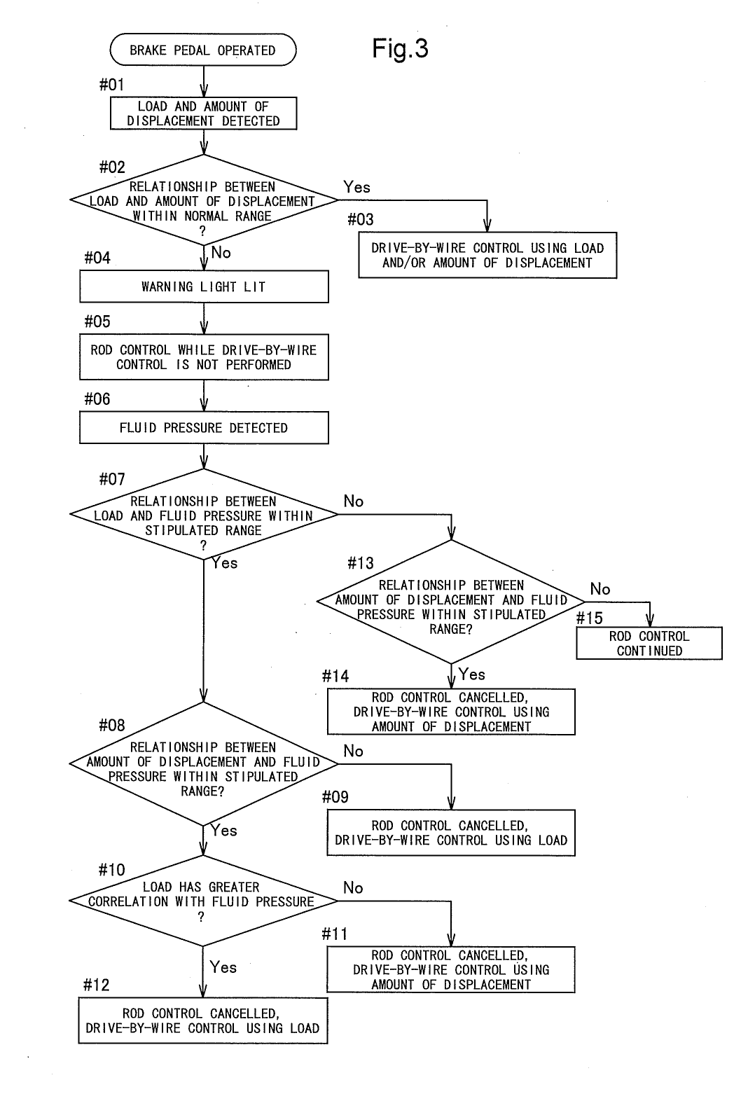

Next, the flow of brake control will be described based on the flowchart of FIG. 3. The load is detected by the load sensor BS1, and the amount of displacement is detected by the displacement sensor BS2 when the brake pedal BP is stepped on (#01). If the relationship between these output values is within the normal range (#02), drive-by-wire control is executed using the load and/or the amount of displacement (#03). In contrast, if the output values are not within the normal range (#02), a warning light indicating the abnormality is lit to alert the driver (#04), and rod control is executed (#05).

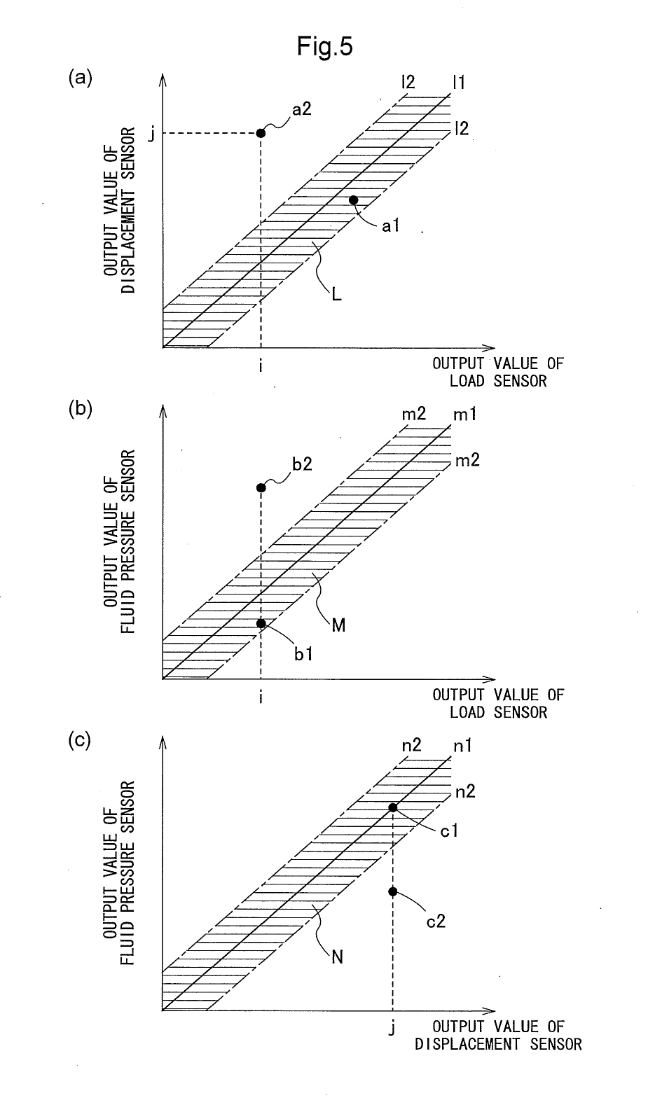

“Normal range” is defined herein as the range indicating that there is no abnormality in the relationship between the load and the amount of displacement, and indicating a relationship in which both of the output values suggest that both sensors are operating normally. For example, the range can be determined as the normal range L shown in FIG. 5(a). In FIG. 5(a), the straight line 11 shows a set of points showing the best correlation between the output values from the load sensor BS1 and the displacement sensor BS2, and the points showing both output values are ideal when they lie on the straight line 11. However, taking into consideration detection errors, noise signals, and other factors that occur in practice, the normal range L is set between the two lines 12 separated by a fixed distance from the line 11.

When the relationship between the load and the amount of displacement is within the normal range L, as is the case with point a1, a determination is made that there are no abnormalities in the load sensor BS1 and the displacement sensor BS2, and drive-by-wire control is executed (#03). However, when the relationship falls outside the normal range L, as is the case with point a2, a determination is made that at least one of the load sensor BS1 and the displacement sensor BS2 has developed an abnormality, the warning light is lit (#04), and rod control is then executed (#05) without drive-by-wire control being performed. The fluid pressure is then detected (#06) using the fluid pressure sensor FS, and the sensor to be used in the drive-by-wire control is identified (#07 to #15) using the output value from the fluid pressure sensor FS.

After the fluid pressure has been detected by the fluid pressure sensor FS (#06), it is first determined whether the relationship between the load and the fluid pressure is within a stipulated range (#07). The stipulated range is similar to the above-mentioned normal range, and the stipulated range M and straight lines m1, m2 in FIG. 5(b) correspond to the normal range L and straight lines 11, 12 in FIG. 5(a). The same applies to FIG. 5(c), which shows the relationship between the output values of the displacement sensor BS2 and fluid pressure sensor FS.

When the relationship between the load and the fluid pressure is within the stipulated range M, as is the case with point b1 of FIG. 5(b), it is determined that the load sensor BS1 is normal, and it is subsequently determined whether the relationship between the amount of displacement and the fluid pressure is in the stipulated range N (#08). When, as a result, the relationship between the amount of displacement and the fluid pressure falls outside the stipulated range N, as is the case with point c2 of FIG. 5(c), it is determined that only the load sensor BS1 is operating normally, rod control is cancelled, and drive-by-wire control is performed using the load (#09).

In contrast, when the relationship between the amount of displacement and the fluid pressure is within the stipulated range N, as is the case with point c1 of FIG. 5(c), it is determined whether the load or the amount of displacement has the greater correlation with the fluid pressure (#10). In other words, it is determined whether point b1 or point c1 is closer to the straight line m1 or n1 in FIG. 5(b) or 5(c). As a result, in a case in which point c1 is closer to the straight line n1, as shown in FIG. 5, it is determined that the amount of displacement has greater correlation with the fluid pressure, rod control is cancelled, and drive-by-wire control is performed using the amount of displacement (#11). In the opposite case, rod control is cancelled and drive-by-wire control is performed using the load (#12).

It is generally unlikely that the relationship with the fluid pressure will be within the stipulated range both for the load and for the amount of displacement, as described above, but a possibility still exists depending on the method for determining the normal range L and the stipulated ranges M, N. In such a case, a disadvantage can arise in that it will not be possible to identify the sensor to be used in the drive-by-wire control merely on the basis of an absolute determination in which it is simply determined whether the relationship is within the stipulated range. It is, however, possible to always identify either of the sensors by providing a relative determination step. Steps #10 to #12 can be omitted in a case in which both the load and the amount of displacement cannot be within the stipulated range because of their relationship with the fluid pressure. The correlations can be compared, for example, by calculating a correlation coefficient to make the determination or the like, or by another technique.

If the relationship between the load and the fluid pressure has been determined to be outside the stipulated range M (#07), as is the case with point b2 of FIG. 5(b), it is subsequently determined whether the relationship between the amount of displacement and the fluid pressure is within the stipulated range N (#13). As a result, if the relationship is within the stipulated range N, as is the case with, for example, point c1 of FIG. 5(c), it is determined that only the displacement sensor BS2 is operating normally, rod control is cancelled, and drive-by-wire control is performed using the amount of displacement (#14). In contrast, if the relationship is outside the stipulated range N, as is the case with point c2, it is determined that an abnormality has occurred both in the load sensor BS1 and in the displacement sensor BS2, and rod control is continued without drive-by-wire control being performed (#15).

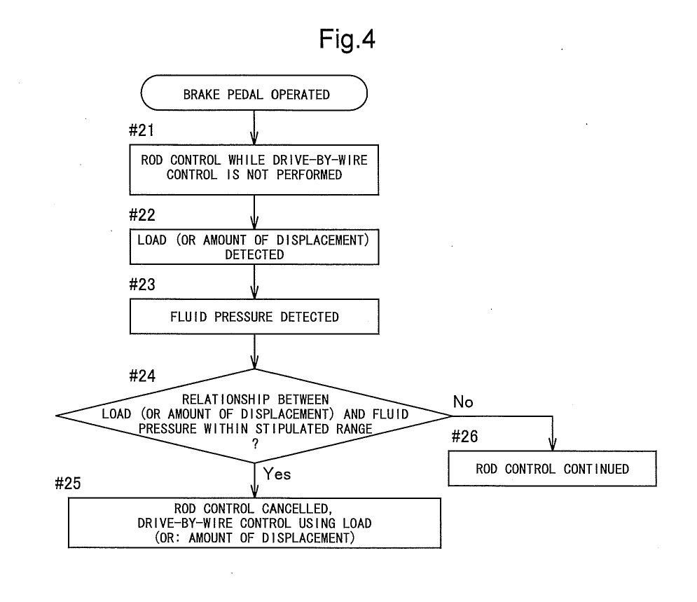

In this configuration, the warning light is continuously lit until, for example, the ignition is turned off when it is determined that the relationship between the load and the amount of displacement is outside the normal range L and the warning light has been lit once. The control shown by the flowchart in FIG. 4 is executed when the brake pedal BP is operated while the warning light is lit.

Rod control is first executed (#21) without drive-by-wire control being performed when the brake pedal BP is operated after the warning light is lit. The output value from the load sensor BS1 or the displacement sensor BS2, which is now used in the drive-by-wire control as the control shown in FIG. 3, is then detected (#22), and the fluid pressure is further detected (#23). It is then determined whether the relationship therebetween is within the stipulated range (#24). Drive-by-wire control is performed (#25) if the relationship is within the stipulated range, and rod control is continued (#26) if the relationship is outside the stipulated range.

Each time the brake pedal BP is thus operated while the warning light is lit, the output value from the load sensor BS1 or the displacement sensor BS2 used in the drive-by-wire control continues to be monitored, making it possible to switch to rod control when the sensors have failed, and to obtain a brake device 1 capable of operating under conditions of secondary failure. It is also possible to dispense with this type of control, assuming the user can promptly perform repairs after the warning light is lit.

The methods for setting the normal range or stipulated range in the present invention are not limited to the embodiment shown in FIG. 5.

### INDUSTRIAL APPLICABILITY

The present invention can be applied to a brake device provided with a plurality of pedal operation detecting sensors for detecting the amount of operation of a brake pedal, and designed to control the electric current value impressed on the motor in accordance with the output value of the sensors.

### KEY

1 Brake device
2 Master cylinder
3 Output piston
A Fluid pressure-generating mechanism
B Control means
BP Brake pedal
BS1 Load sensor
BS2 Displacement sensor
FS Fluid pressure sensor
M Motor

What is claimed is:

1. A brake device comprising:
a master cylinder for generating fluid pressure corresponding to the operation of a brake pedal;
a braking mechanism for receiving the fluid pressure generated by the master cylinder, and applying braking force to a wheel using the supplied fluid pressure;
a plurality of pedal operation detecting sensors for detecting the amount of operation on the brake pedal;
a fluid pressure-generating mechanism driven by a motor to generate fluid pressure and to supply the generated fluid pressure to an input side of the braking mechanism;
control means for controlling the electric current value impressed on the motor in accordance with the output values of the pedal operation detecting sensors; and
a fluid pressure sensor for detecting fluid pressure supplied to the input side of the braking mechanism;
wherein the control means controls the electric current value impressed on the motor in accordance with the output values from the plurality of pedal operation detecting sensors in a case in which the relationship of the output values is within a predetermined normal range; and
identifies the pedal operation detecting sensor for use in controlling the electric current value to be impressed on the motor on the basis of the relationship between each of the output values from the plurality of pedal operation detecting sensors and the output value from the fluid pressure sensor in a state in which no electric current is being impressed on the motor in a case in which the relationship of the output values from the plurality of pedal operation detecting sensors is outside the normal range.

2. The brake device of claim 1, wherein
the fluid pressure-generating mechanism is constructed from the master cylinder and an output piston for causing fluid pressure to be generated in the master cylinder, and the output piston is controlled by the motor.

3. The brake device of claim 1, wherein
a determination is made as to whether the relationship between each of the output values from the plurality of pedal operation detecting sensors and the output value from the fluid pressure sensor is within a predetermined stipulated range, and the pedal operation detecting sensor for use in controlling the electric current value to be impressed on the motor is identified in a case in which the relationship of the output values from the plurality of pedal operation detecting sensors is outside the normal range.

4. The brake device of claim 2, wherein
a determination is made as to whether the relationship between each of the output values from the plurality of pedal operation detecting sensors and the output value from the fluid pressure sensor is within a predetermined stipulated range, and the pedal operation detecting sensor for use in controlling the electric current value to be impressed on the motor is identified in a case in which the relationship of the output values from the plurality of pedal operation detecting sensors is outside the normal range.

5. The brake device of claim 1, wherein
the correlation between each of the output values from the plurality of pedal operation detecting sensors and the output value from the fluid pressure sensor is compared, and the pedal operation detecting sensor for use in controlling the electric current value to be impressed on the motor is identified in a case in which the relationship of the output values from the plurality of pedal operation detecting sensors is outside the normal range.

6. The brake device of claim 2, wherein
the correlation between each of the output values from the plurality of pedal operation detecting sensors and the output value from the fluid pressure sensor is compared, and the pedal operation detecting sensor for use in controlling the electric current value to be impressed on the motor is identified in a case in which the relationship of the output values from the plurality of pedal operation detecting sensors is outside the normal range.

7. The brake device of claim 1, wherein the plurality of pedal operation detecting sensors includes a displacement sensor for detecting the amount of movement of the brake pedal, and a load sensor for detecting the operating force on the brake pedal.

8. The brake device of claim 2, wherein the plurality of pedal operation detecting sensors includes a displacement sensor for detecting the amount of movement of the brake pedal, and a load sensor for detecting the operating force on the brake pedal.

9. The brake device of claim 3, wherein the plurality of pedal operation detecting sensors includes a displacement sensor for detecting the amount of movement of the brake pedal, and a load sensor for detecting the operating force on the brake pedal.

10. The brake device of claim 5, wherein the plurality of pedal operation detecting sensors includes a displacement sensor for detecting the amount of movement of the brake pedal, and a load sensor for detecting the operating force on the brake pedal.
